(19) United States
(12) Patent Application Publication
(10) Pub. No.: US 2009/0171980 A1
(43) Pub. Date: Jul. 2, 2009

(54) METHODS AND APPARATUS FOR REAL ESTATE IMAGE CAPTURE

(76) Inventors: William D. Meadow, Jacksonville, FL (US); Matthew Pavelle, Jacksonville, FL (US)

Correspondence Address: Joseph P. Kincart, Esq., 8153 Middle Fork Way, Jacksonville, FL, 32256, US

(21) Appl. No.: 12/344,004

(22) Filed: Dec. 24, 2008

Related U.S. Application Data
(60) Provisional application No. 61/009,147, filed on Dec. 24, 2007.
(60) Provisional application No. 61/009,181, filed on Dec. 24, 2007.

(51) Int. Cl. G06F 17/30; G01C 21/36

(52) U.S. Cl. 707/10; 701/209; 701/200; 707/E17.01

(57) ABSTRACT

The present invention includes methods and apparatus for processing requests for image data. In particular, some embodiments include receiving a request for image data descriptive of a subject parcel and dispatching an image data capture device rig to capture image data along a calculated route as well as the subject property.

### CROSS REFERENCE TO RELATED APPLICATIONS

The present application claims priority to pending patent application Ser. No. 12/135,170, filed, Jun. 6, 2008 and entitled, “Apparatus and Method for Producing Video Drive-By Data Corresponding to a Geographic Location,” the contents of which are relied upon and incorporated by reference, and also Provisional Patent Application Ser. No. 61/009,181 and entitled Methods and Apparatus for Real Estate Image Capture filed Dec. 24, 2007, the contents of which are relied upon and incorporated by reference and also Provisional Patent Application Ser. No. 61/009,147 and entitled Methods and Apparatus for Associating Image Data filed Dec. 24, 2007, the contents of which are relied upon and incorporated by reference.

### FIELD OF THE INVENTION

The present invention relates to methods and apparatus for providing image data related to a subject real estate parcel.

### BACKGROUND OF THE INVENTION

Image recorders have been used to capture various views of a geographic location and in numerous formats. Photographs, movie cameras, video camera recorders, and more recently digital recorders have all been utilized to capture images of a real estate parcel. More recently, aerial views of a geographic location have been generated from aircraft, satellites and the like. Each format is distinct, in both its method of capture and its association with data descriptive of a particular image.

Generally, business needs would dictate a chosen format of image data. For example, a real estate broker may display various aspects of a real estate parcel in still pictures or video capturing such aspects. A real estate appraisal may require still photos of a particular aspects of a real estate parcel, such as, for example, a frontal view, a street view and a rear view. Comparable sales properties will typically also be treated in a similar manner.

Previously an appraiser would receive a request for a valuation of a subject real estate property and research Comparable Real Estate properties. The appraiser would then schedule an appointment to review the subject property. Sometimes the appointment would not be scheduled for several days. At the scheduled appointment time, the appraiser would travel to the subject real estate parcel and take pictures with a camera. In addition, the appraiser would need to travel to the Comparable Real Estate Properties and also take pictures of the each of those properties. The process is time consuming and inefficient. In particular, during market conditions that require a high volume of real estate appraisals, previously known apparatus and methods may not be efficient enough to meet demands in a timely manner. In addition, in some instances, a bank or other financial institution may wish for an indication of a general status of a subject property and properties in close proximity to the subject property.

### SUMMARY OF THE INVENTION

Accordingly, the present invention provides methods and apparatus for uniquely identifying a subject real estate parcel; capturing image data of the subject real estate parcel in a timely and efficient manner and transmitting image data of the subject parcel to a user.

In some embodiments, the present invention also includes methods for generation of image data capture routes and image data delivery systems for timely delivery of user requested image data related to a subject real estate parcel.

Embodiments can therefore include apparatus, methods and stored instructions to facilitate processing information related to the integration of multiple sources of image data, as well as a method for interacting with a network access device to implement various inventive aspects of the present invention.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

As presented herein, various embodiments of the present invention will be described, followed by some specific examples of various components that can be utilized to implement the embodiments. The following drawings facilitate the description of some embodiments:

FIG. 1 illustrates an exemplary camera array for capturing multiple image continuums.

FIG. 2 illustrates an alignment of image data screens.

FIG. 3 illustrates a block diagram of a subject property and an image data capture path.

FIG. 4 illustrates a block diagram of a subject property and an indication of a centroid of individual real estate properties.

FIG. 5 illustrates a block diagram of a subject property and an indication of multiple lines of sight for image data capture.

FIG. 6 illustrates a block diagram of method steps that may be implemented in practicing the present invention.

FIG. 7 illustrates a flow chart of steps of related to image data capture routes.

FIG. 8 illustrates designation of one or more subject real estate parcels via an aerial view.

FIG. 9 illustrates a block diagram of apparatus that may be used to implement various aspects of the present invention.

FIGS. 10A-10B illustrate a user interactive apparatus for delivering image data to a user.

### DETAILED DESCRIPTION OF PREFERRED EMBODIMENTS

The present invention provides methods and apparatus for efficiently capturing and managing image data of a subject real estate parcel. Generally, image data is captured and stored with an ability to associate portions of the image data with particular real estate parcels. A request can be received for image data of a particular subject real estate parcel. If sufficient relevant image data descriptive of the subject real estate parcel is available in the stored image data, then relevant image data is packaged and transmitted to a user requesting such data. If sufficient relevant data is not already stored, then a rig including multiple IDCDs is dispatched to capture required data. Typically, image data is captured in a 360° arc along a designated travel route to and from the subject real estate property.

In some embodiments of the present invention, IDCDs capture disparate image data along such a travel route. At least a portion of image data captured by a given IDCD relates to overlapping subject matter with a portion of image data captured by another IDCD. The disparate image data related to the overlapping subject matter is integrated to present an aggregated view of data related to the subject. Although image data capturing a subject real estate parcel is ultimately packaged and transmitted, image data of areas nearby the subject real estate parcel can also be captured, such as, for example, real estate neighboring real estate properties and property along various routes approaching or leaving the subject real estate parcel.

In some preferred embodiments, multiple IDCDs point in various directions from a centric point. The various directions in which the IDCDs point can be generally coplanar or directed at different altitudes from the centric point.

Another aspect of the present invention includes apparatus and methods for disseminating and viewing the integrated image data. An image data server can transmit integrated image data related to a particular spatial designation to a user interactive device and automatically generate and transmit additional image data in anticipation of a user's next request for image data.

### DEFINITIONS

As used herein, “Comparable Real Estate Property” of “Comparable” refers to a real estate property of similar attributes to a subject real estate parcel, such as, for example, of similar size, location, style and condition.

As used herein, “Flash Viewer” (Streaming Video) refers to direct streaming of video to an online user via a web browser.

As used herein, “Image Data Capture Device” or “IDCD” refers to an apparatus capable of capturing image data of a spatial designation. An example of an Image Capture Device includes a digital camera with a lens appropriate for a predetermined spatial designation.

As used herein, a “Modality” refers to a mode of image data including: a) the capture of image data from a unique perspective in relation to a subject captured in the image data, as compared to other modes; or b) the presentation of image data from a unique perspective in relation to the subject matter captured in the image data as compared to other modes.

As used herein, “Video DriveBy™” Modality refers to a presentation modality of street level image data captured in multiple angles, and in some embodiments encompassing a 360° view.

As used herein, “RibbonView™” refers to a two dimensional continuum of image data with filmstrip like view of properties, which provides direct-on front images of a subject to be displayed.

As used herein, a “UUID” refers to a universally unique identifier and is an identifier standard associated with software implementations and standardized by the Open Software Foundation (“OSF”) as part of the Distributing Computing Environment (“DCE”). Some exemplary embodiments of UUIDs include globally unique identifiers (GUIDs) from Microsoft.

As used herein, “Video FlyBy™” refers to Aerial/Satellite oblique (angular) view image data with polygon line views.

As used herein, “Virtual Walkabout™” refers to a virtual mode of accessing image data which emulates walking through a scene presented. Preferred embodiments include walking through a scene created by spraying actual image data over three-dimensional models generated based upon the image data.

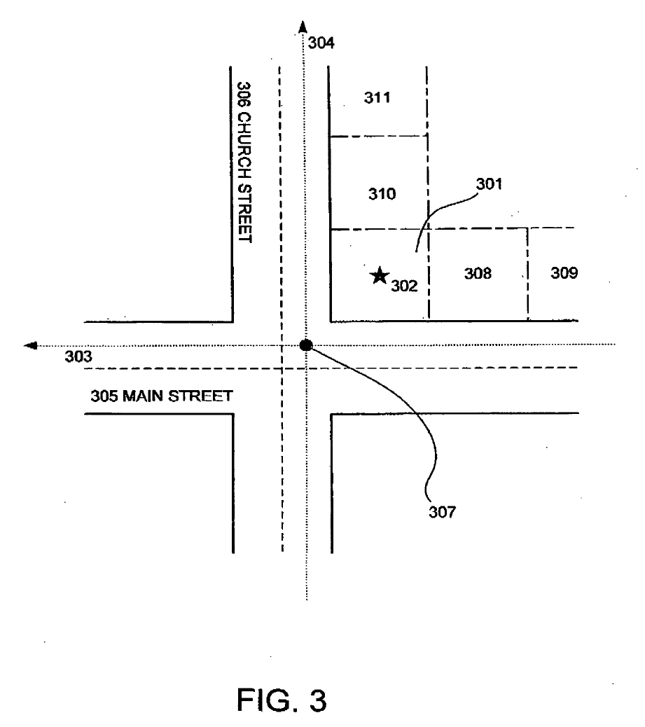

Referring now to FIG. 3, a block diagram is illustrated of a subject real estate property 301. The subject property can be identified in any user ascertainable manner, such as, by way of example: street address; owner and street address; tax map number; county identification number; state identification number; UUID; GPS coordinates; and subdivision lot number. A subject property centroid 302 can be calculated based upon the geometric parameters of the subject property. For example, a bank may need an valuation for a property 301 serving as collateral for a mortgage note. The bank may therefore identify a subject property according to a street address, such as 77 Main Street, Yourtown, State USA.

According to some embodiments of the present invention, a street address is correlated with a real estate parcel map, sometimes referred to as a tax map, utilized by an appropriate municipality. Image data, and in some cases, other types of data associated with the image data, can be correlated with the real estate parcel map. A geometric shape correlating with a real estate parcel can be used to define which datum pertain to a particular real estate parcel. For example, geographic parameters of 77 Main Street are reduced to a geometric shape and a centroid 302 is calculated for the shape. In addition, in some embodiments, Cartesian coordinates, such as GPS coordinates can be used to identify the centroid location and boundaries defined by the subject property lines. A database of image data can be searched for data related to one or more of the centroid and the real estate property boundaries. Associated image data can be presented to a user, other data can also be presented to a user which relates generally to the image data or location

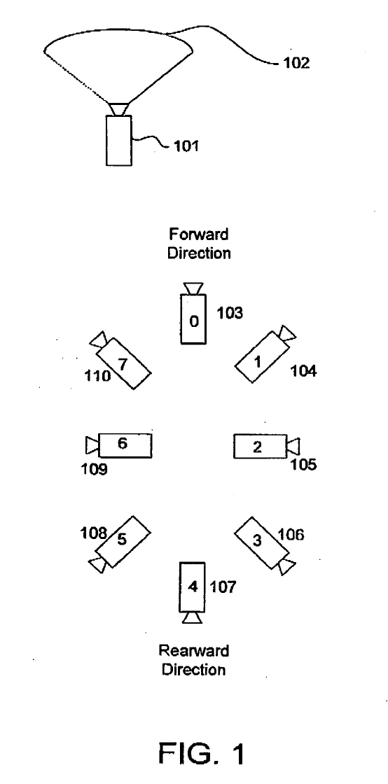

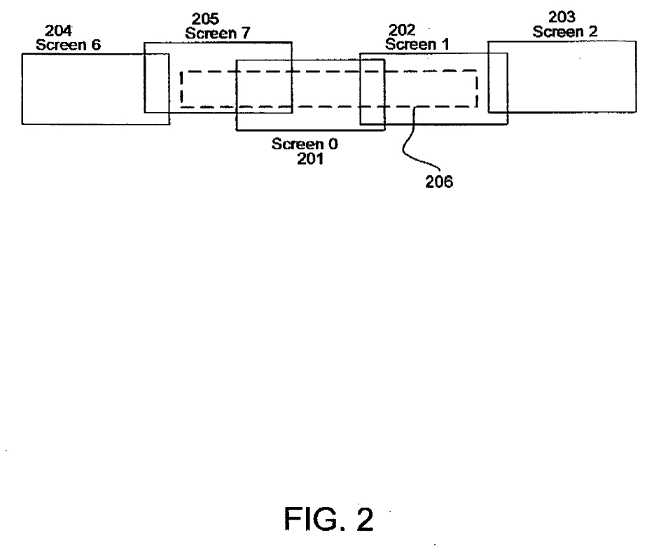

A stored database can also include data indicating one or more paths 303-304 from which IDCDs captured image data. As discussed further below, such as with regard to FIGS. 1-2, an IDCD rig can include multiple IDCDs, with each IDCD fixed to capture image data in a particular direction, relative to the other IDCDs. According to the present invention, an image data capture route 303-304 of an IDCD rig can be considered, as well as one or more spatial designations of individual IDCDs. Typically, the images captured in a spatial designation are based upon the orientation of particular IDCDs comprising the rig and the route traveled by the rig.

In some embodiments, a time designation can be associated with captured image data. A time designation can include, for example, a date on which image data is acquired. If a request for image data is date sensitive, a calculation can be made to ascertain whether a date of image data capture is within a window of time acceptable to a particular application. If such a calculation indicates that stored image data is within an acceptable window of time, then stored data can be transmitted to a user making a request. If stored data is not within a threshold window of time, and the threshold window of time is in a present or future timeframe, then one or more IDCDs can be dispatched to acquire current image data.

In some embodiments, one or more IDCDs can be dispatched according to a predefined image data capture route 303-304 and time designation. In addition, a preferred image data capture route 303-304 can be calculated to include geographic areas of interest,

In another aspect, some embodiments can include storing data descriptive of a path of travel or data capture route 303-304 of an IDCD rig and a date during which the rig captured data from the data capture route 303-304. A data capture route 303-304 can be generated, for example, by plotting GPS coordinates recorded during data capture. The plot can be represented in a linear fashion and, in some cases overlaid on a map of an area traveled during the data capture. Analysis of stored data descriptive of one or both of a subject property 301 and a centroid 302 can be used to determine which portions of which data capture routes 303-304 would have captured image data of one or both of a subject property 301 and a subject property centroid 302. Some embodiments can include a description of those portions of a data capture route 303-304, such as for example, UUIDs associated with individual images.

In some embodiments, portions of multiple data capture routes 303-304 can be connected into a contiguous route and image data associated with the connected portions 303-304. Some embodiments can also include the associated image data being presented as a contiguous body of data, joined for example at an intersection point 307. For example, UUIDs associated with portions of image data can be sequenced. The image data can then be presented to a user according to the sequence.

As illustrated, and by way of non-limiting example, a subject property 301 located at 77 Main Street may be viewable from a first data capture route 303 following portions of Main Street 305. Data associated with the first data capture route may have been captured on a first date, such as May 10 of current year. UUIDs of the data captured on May 10 of the current year can be sequenced for presentation. The subject property 301 may also be viewable from a second data capture route 304 following portions of Church Street 306. Data associated with the second data capture route may have been captured on a second date, such as June 5 of current year. The associated June 25 UUIDs may also be sequenced. In some embodiments, image data UUIDs associated with a first data capture route 303 can be concatenated UUIDs from a second data capture route 304 and data with the concatenated UUIDs can be presented. As illustrated, the concatenation would form a virtual corner, however, those schooled in the art will realize that other configurations are also within the scope of the invention. The combined image data can be presented to a user in a manner that allows the user to virtually traverse a route formed by the concatenated data and turn a corner at the intersection point 307. Although data captured on different dates may include some incongruencies, such as, for example, different seasonal effects or different weather, or even just different positions of the sun, the ability to traverse all image capture routes provides a comprehensive view of available data.

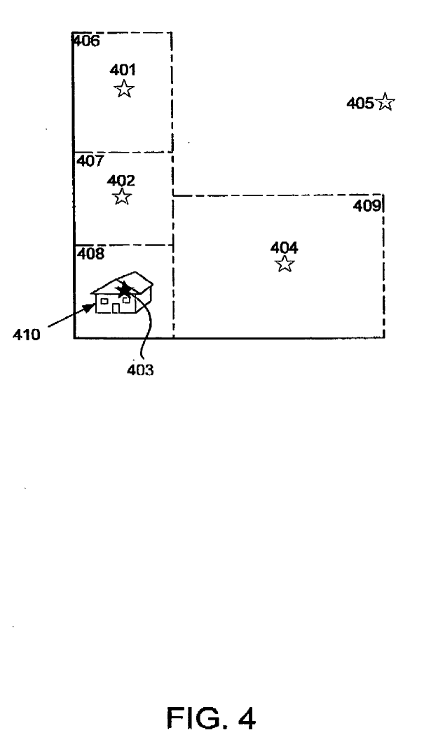

Referring now to FIG. 4, multiple subject property centroids 401-405 are illustrated, each associated with a subject property. According to some embodiments of the present invention, a physical location can be associated with a geopolitical delineation, such as a real estate parcel map, a real property map, a tax map, a subdivision map, or other means for parsing a geographic area into subparts. The present invention has determined that statistically, if an improvement, such as a building, is present on a subject property 406-409, a respective centroid 401-404 will intersect the improvement most of the time. Therefore, the present invention provides for capturing data, including image data of an area that includes the centroid 401-404 of a subject property 406-409.

By way of non-limiting example, satellite image data can be overlaid with lines that represent a county real estate parcel property map according to Cartesian coordinates, such as GPS designations. One or more subject property centroids 401-405 can be calculated and associated with respective subject properties. A request for image data of a particular address can be received, and image data can be provided based upon a centroid for the requested address. Methods for ascertaining which data is associated with a particular centroid 401-405 are discussed below.

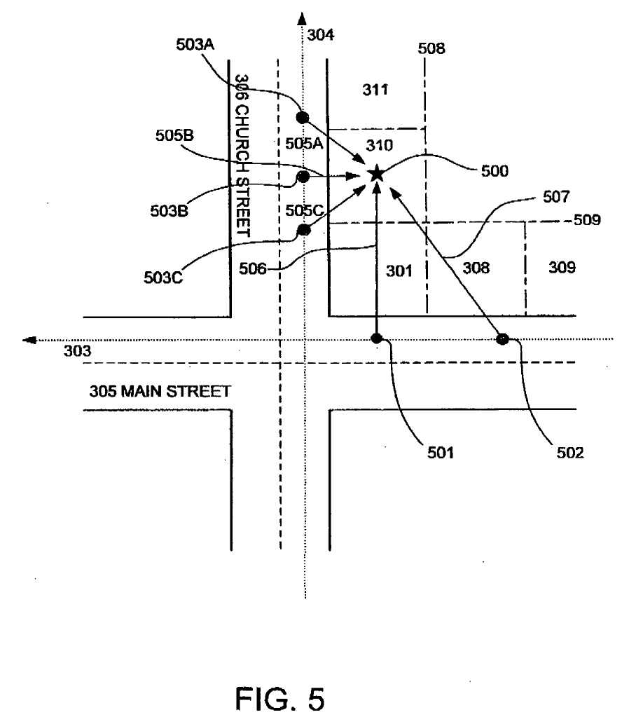

Referring now to FIG. 5, a block diagram of an exemplary overlay is illustrated. A centroid 501 is indicated on a particular subject property 310. As discussed above, the centroid is calculated according to the geometric properties of the subject property 310.

Records of image data capture routes 303-304 can be stored and points 501-502 503A-B along the routes 303-304 can be determined from which vectors 505A-B 506-507 can extend which will intersect a designated centroid 500. The vectors 505A-B 506-507 extend from the image data capture routes 303-304 at an angle equivalent to the angle a corresponding IDCD 0-7 is pointed from a vehicle rig during the image data capture. As illustrated, some vectors 505A-C will originate from a route 304 on a street directly adjacent to a subject property 310. In other embodiments, a vector may originate on a route 303 from a street that does not border the subject property 310.

In some embodiments, a vector 506-507 may cross over more than one property boundary 508-509 before it captures image data of a subject property 310. Calculations of the length of a vector 505A-B 506-507 and an arc of vector angles can be made according to a spatial designation associated with a respective IDCD. For example, if an IDCD can capture high quality image data up to a distance of 300 meters and an IDCD has a 65° arc or view, a calculation can be made from points along an image data capture route 303-304 to determine whether the IDCD is capable of capturing image data of a subject property. In some instances, vectors 506-507 will need to cross multiple property boundaries 508-509 in order to capture the applicable image data of the subject property 310.

Some embodiments can also include calculations that begin with a subject area or point, such as points along a subject property boundary or a subject property centroid 500 and calculating rays outward. The outward rays can be used to correlate one or more image data capture routes 303-304 or to ascertain whether an already existing image data capture route 303-304 can may have captured image data of the subject area or point.

Accordingly, in some embodiments, a vehicle with an IDCD rig may be dispatched to drive a route that includes a street on which the subject property has road frontage and other routes that includes streets other than a street included in an address of the subject property 310 or other that a street on which the subject property 310 has road frontage, in order to capture image data related to the subject property 310.

Referring now to FIG. 1, an exemplary layout of a rig of IDCDs 101A-B is illustrated. The configuration of the IDCD rig allows for simultaneous capture of image data in an arc up to 360°. Each IDCD is associated with a relative spatial designation 102A-B from which the IDCD is capable of capturing image data. An arrangement 100 of multiple IDCDs 0-7 can be arranged to capture image data from different directions 103-110 and function as disparate sources of image data. In some embodiments, IDCDs 0-7 can be secured in a generally planar manner and positioned to capture generally planar image data. Alignment of captured image data from respective spatial designations 102 may take place without artificial delay, or via post processing. In some instances, image capture data can include data received from laser assisted radar (“LADAR”) or other data that facilitates processing of three dimensional distances and features.

Multiple IDCDs located proximate to each other can capture image data during a designated time period and be time stamped to correlate data received from each IDCD. In addition, in some embodiments, the IDCDs can be arranged to capture data during contiguous instances of time as if from a single point of view X. The point of view may, for example, be concentric, from an oblong configuration, or from a polygon configuration.

In some embodiments, a respective spatial designation 102 for a camera 0-7 may be positioned at a given location to overlap with a respective spatial designation 102 of an adjacent camera 0-7. Embodiments where multiple cameras are positioned to capture data from a single point of view can include the simultaneous capture of image data in a horizontal, vertical or combination thereof arc of up to 360°. According to some embodiments of the present invention, each spatial designation may be associated with a UUID. Other variables may also be associated with a UUID, such as, for example, the location from which spatial designations were determined or individual or multiple frames of image data.

In various embodiments of the present invention, integrated image data may be viewed as a single frame or as a streaming continuum of image data; or as a horizontal, vertical or combination therein, arc view of image data from a point of view comprising a spatial designation. The arc view can include up to a horizontal 360° arc, essentially emulating a human experience of standing at a location, at a particular moment in time and turning around. A spatial designation can include any mechanism defining a location and according to some embodiments of the present invention, each spatial designation can be uniquely associated with a UUID.

Referring now to FIG. 2, according to some embodiments of the present invention, a single frame of image data can include image data correlating with adjacent disparate IDCDs 0-7. The image data can be presented on adjacent portions of one or more display portions 201-205. As discussed above, such image data captured from disparate IDCDs 0-7 correlates with respective spatial designations 102. Coordinates are calculated for aligning image data from adjacent portions. Alignment can be accomplished, for example, according to common features present in the respective portions 201-205 of image data, wherein the features are ascertained via known pattern recognition techniques. As recognized patterns are ascertained along border portions of adjacent images, the images may be adjusted in a vertical and horizontal dimension to align the patterns.

Alignment of image data captured by a first IDCD 0-7 and an adjacent second IDCD 0-7 may compensate for any physical factor responsible for misalignment of adjacent first and second IDCDs 0-7 utilized to capture the image respective portions of image data 201-205. Physical factors may include, for example, irregularities of a mounting surface to which the IDCDs are mounted, a slope in a roadway from which the image data is captured, an irregular road surface or other factor.

According to the present invention, a composite image portion 206 is composed of two or more aligned display portions 201-205. Included in the alignment is an overlay area 207-208 that is used to blend a first image portion 201-205 with a second image portion 201-205. In some embodiments, blending can include combining some pixels of data from a first image portion 201-205 with pixels of data from a second image portion 201-205. Some embodiments can also include modification of an overlapping pixel of data according to the colors of the overlapping pixels, still other embodiments can include standardized mechanisms, such as an Alpha blending mechanism of computer graphics programming. Some embodiments can therefore include an overlay area 207-208 presented as a single frame of a subject real estate property.

As illustrated, the composite image portion 206 spans across aligned image data comprising Screen 0 201, Screen 1 202 and Screen 7 205. In some respects, the aligned image portion 206 emulates a field of view of a person viewing an area captured in the image data, with binocular or greater sources of image data combined into a single composite image portion 206.

According to some embodiments, a user computing device will request image data correlating with, or descriptive of, a spatial designation. The user computing device includes any apparatus with a display capable of producing an image in human recognizable form. Typically, the user computing device will also include a processor and a digital storage apparatus. A computer server will download image data to the user computing device. The downloaded data will have been stored on the server from multiple IDCDs which simultaneously captured image data associated with the spatial designation. The downloaded image data will include the captured image data that is included in a composite image portion 206. The downloaded data can also include coordinates for downloaded aligning image data that was captured from the multiple disparate IDCDs 0-7.

As discussed herein, an electronic document may include a certified single frame image and may also include a link to additional image data generally related to the subject real estate property; the generally related image data may include real estate along nearby streets or of common interest. Some embodiments of the present invention provide data available for downloading with a 360° view captured simultaneously from a given point of view.

In some preferred embodiments, a field of view is specified by a user. For example, a user may input a subject that the user desires to view. The subject may include, by way of example, a subject real estate parcel. Relevant image data can be identified that includes image data descriptive of the subject. The identified image data will typically include a 360 degree view of a location of the subject. Image data first downloaded will include a field of view that includes the subject. A field of view may include, for example a 135° field of view that includes the subject. The field of view image data will download first, along with the alignment coordinates and a user computing device will construct a field of view image based upon the downloaded image data and the alignment coordinates. Once all field of view image data has been downloaded, additional image data sets that are included in a 360° composite of the subject location can continue to download (sometimes referred to as “backfilled image data”). Still further downloaded data can include image data of adjacent subject matter. Additional data can anticipate a user request to view adjacent fields of view.

By way of example, a 135 degree field of view can initially be requested by a user of a particular subject area, such as a real estate parcel. Responsive to the request, a server containing image data can download sets of image data from multiple IDCDs 0-7 that include image data of the subject area. In addition, coordinates can also be downloaded which facilitate alignment of the image data sets from the disparate IDCDs 0-7. After the initial 135° field of view has been downloaded, additional fields of view may also be downloaded.

Some additional embodiments can include an image of a map of a general area including the subject area. An avatar, or a virtual vehicle can travel the map according to the subject area currently displayed as a composite image. Other embodiments can include an aerial view and an indictor on the aerial view as to which subject area is currently displayed as a composite image. Still other embodiments can include selecting a point on a map or an aerial view and viewing composite image data of the selected point, wherein the point acts as an indicator of the subject matter.

In another aspect, a high resolution imagery of a subject area can automatically download when a virtual vehicle or avatar used to travel a map or aerial view, virtually stops at a location. For example, when the avatar stops on a map and a low resolution 360° view of the subject area located by the avatar has competed downloading to the user computing device, the server can automatically begin to transmit to the user computing device high resolution data of the subject area. In addition, some embodiments can include a visual indication of a virtual vehicle or avatar location on the map or aerial view.

In still another aspect, a view presented to a user can auto-track a property, such as a subject property, as a virtual vehicle is moved in virtual proximity to a subject property. For example, a 135° degree view, or any user view described herein, can stay focused upon a subject property as a perspective for the view of the subject property is changed according to the virtual location of the virtual vehicle. In this respect, a Video DriveBy can be replayed according to the relative view from the virtual vehicle.

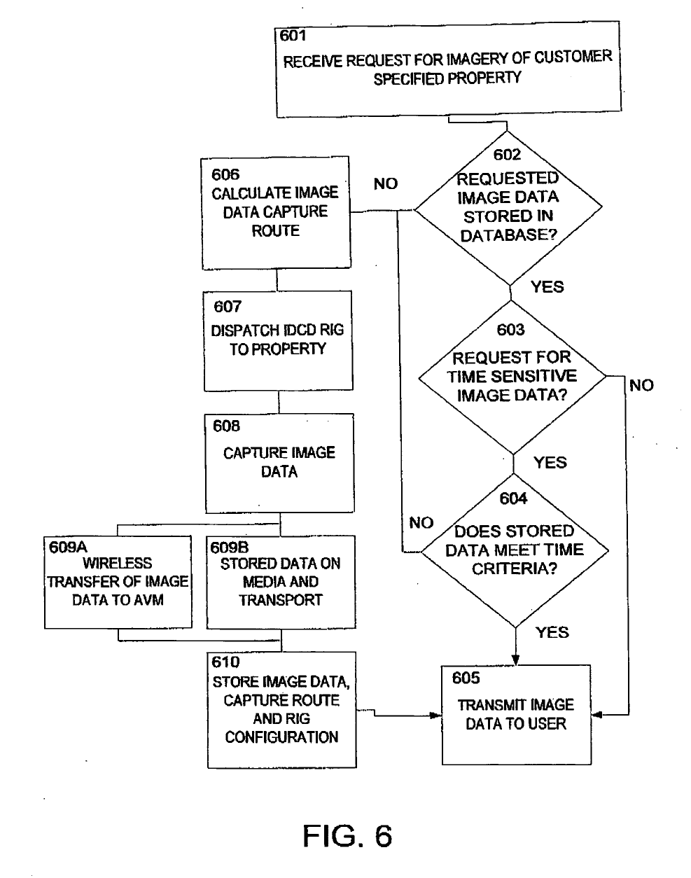

Referring now to FIG. 6, a flow chart of exemplary process steps that can be executed to implement the present invention is illustrated. All method steps discussed herein are exemplary and not meant to be exclusive. In addition, although they are discussed in a particular sequence, some or all of the steps may be accomplished in other orders. At 601, a real estate parcel image generator service can receive a request for image data of a subject property. Preferred embodiments include a same day service request. A request for subject property imagery can be received via voice, fax or electronic communication and can include any identifier for ascertaining a real estate parcel or area. Identifiers can include, for example, one or more of: a street address, a tax map number, a county map parcel number, a national grid number, a Cartesian coordinate, a GPS designation and a UUID.

At 602, a query can be made of stored image data to ascertain if the requested image data is available in a stored database. If the requested image data is available in the stored data, at 603 a check can be made to ascertain if the request included time sensitive criteria. For example, a request may specify that the image data not be more than one week old, or six months old, or any other time designation. If the request does not include a time designation, some or all of the correlating stored image data can be transmitted to the requesting user at 605. If the request does include a time criteria, at 604 a test can be made to ascertain if the stored data meets the time criteria. If the stored data does not meet the timing criteria, then at 606, a image data capture route can be calculated.

Referring now again to the determination of whether requested image data is available in a stored database 602, if the data is not available, then an image data capture route is also calculated 606.

At 606, in some embodiments, an image data capture route can be calculated according to multiple criteria, including: location of available IDCD rigs; time priority of a request; available image data; subjects of interest in proximity to route points; location of comparable properties; traffic patterns; other requests for image data of other subject properties; a location of the sun in relation to an image data capture position; elevation of an image data capture point in relation to a subject property; or other criteria. In some embodiments, a image data capture route can also include a walking portion during which image data is captured with an operator borne image data capture device, such as a handheld camera.

At 607 an IDCD rig can be dispatched to a requested subject property. Dispatch can be according to many known means, including, for example: voice instruction, email, wireless application transmission, and text messaging. The dispatch can include a designated route and time criteria associated with the request. A vehicle stationed computer that works in correlation with the dispatched IDCD rig will typically include a GPS unit that can monitor the location of a vehicle transporting the IDCD rig. In some embodiments, location data from the GPS can be transmitted via a wireless network to a central station. Updates on which data has been captured, in relation to respective GPS locations can also be transmitted and stored. In this manner, a central station can be constantly updated on the progress of a dispatched request.

At 608, image data can be captured. It is important to note that image data can be captured not only of the subject property for which a request was made, but also for real estate areas viewable along a dispatched route. In some embodiments, a resolution of data capture for portions of a route other than a subject property can be captured at a lower resolution than the image data captured of the subject property. At 609A-B, captured image data can be processed by one or both of: wirelessly transmitted to a predetermined destination, such as an AVM, and stored on a storage medium connected to the IDCD rig. In some preferred embodiments, image data can be stored on a local hard drive and also transmitted. Of course it is also within the scope of the invention to create a storage medium, such as burn a CD and transport the media to a user 609B.

At 610, it is preferable for all of the data captured along an image data capture route to be stored in a central data storage, such as, for example an array of hard drives. In addition to the image data, a image data capture route and rig configuration can also be stored. Other related data, can also be stored, such as: a time of day of data capture, a date of data capture, a relative position of the sun, a speed at which the image data was captured, a resolution of the image data, and other related information.

Returning now again to 605, ultimately, requested image data will be transmitted to a user requesting the image data.

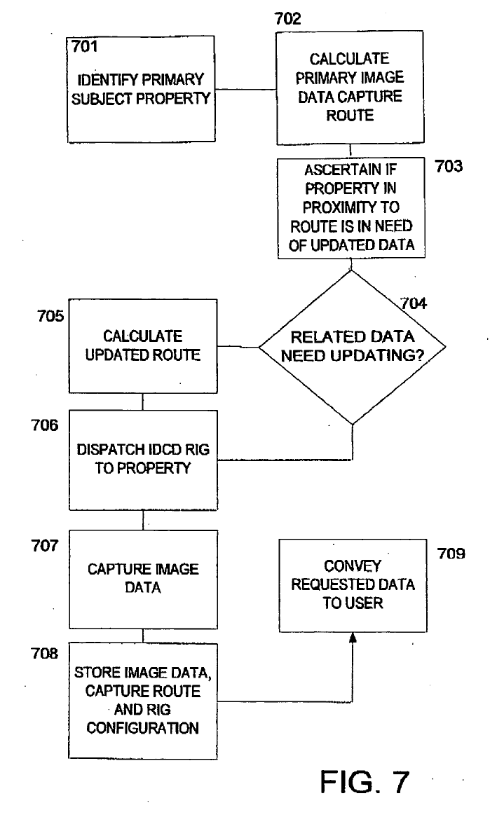

Referring now to FIG. 7, in some embodiments, an objective of a service provider will include creation of a comprehensive database of up to date image data of a geographic area. Towards that end, when a request for image data of a particular property is received, at 701 a primary subject property can be identified. At 702, a primary image data capture route can also be calculated. However, at 703, a secondary objective of updating image data that may be accessible en route to the primary subject matter can also be considered and a calculation can be made to ascertain if property in proximity to a calculated route is in need of updating. At 704, a determination can be made related to the need for updating. If the data does not need updating, then at 706, an appropriate IDCD rig can be dispatched. However if at 704 the data is in need of updating, at 705 an updated image data capture route can be calculated and then the IDCD rig can be dispatched along the updated route 706.

At 707, image data can be captured, including image data of the subject property and of the areas in need of updating. At 708 the image data and the capture route and rig configuration and related data can be stored, and at 709 image data related to a received request can be transmitted to a requesting user, while the additional supplemental data has been stored in an updated database. In this manner, efficiencies can be built into dispatched routes.

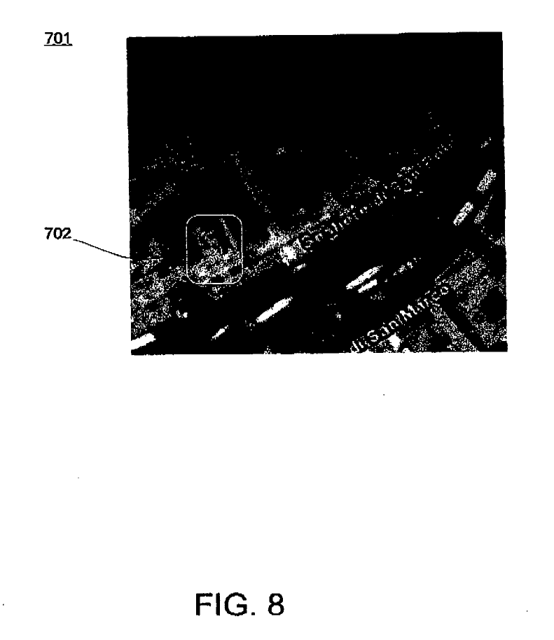

Referring now to FIG. 8, in another aspect of the invention, a subject property can be designated in many modes, and one mode can include a designation made in correlation with an aerial view, such as a satellite view of a geographic area 701. In some embodiments, a user can outline an area 702 that will be designated for image data capture. In additional embodiments, a user will be able to view an overlay of geopolitical boundaries, such as individual parcels on an aerial view, and select a parcel as outlined. Still additional embodiments, can include selection of multiple parcels with a user interactive device, such as a mouse, touch screen or keyboard. Preferably, each parcel will be uniquely identified with a designator, such as a parcel number or UUID.

It should be noted that although this description generally refers to the capture of image data, most embodiments can also include the capture of other data related to an subject property. Additional data may be related to image data by one or more of: an instance in time; a geographical location and a UUID. By way of non-limiting example, additional data may include: global positioning data, cell tower location data, grid location data, elevation data, directional data, LADAR data, WiFi or other data signal data, cellular reception data, noise level data, or other location specific data.

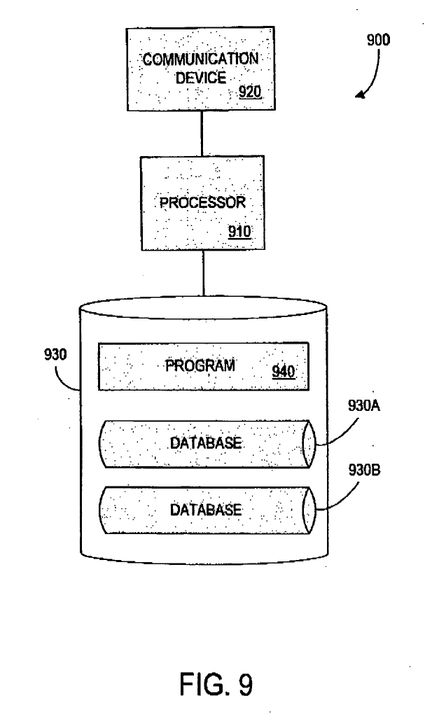

FIG. 9 illustrates a controller 900 that may be embodied in one or more of the above listed devices and utilized to implement some embodiments of the present invention. The controller 900 comprises a processor unit 810, such as one or more processors, coupled to a communication device 920 configured to communicate via a communication network (not shown in FIG. 9). The communication device 920 may be used to communicate, for example, with one or more online devices, such as a personal computer, laptop or a handheld device.

The processor 910 is also in communication with a storage device 930. The storage device 930 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 930 can store a program 940 for controlling the processor 910. The processor 910 performs instructions of the program 940, and thereby operates in accordance with the present invention. The processor 910 may also cause the communication device 920 to transmit information, including, in some instances, control commands to operate apparatus to implement the processes described above.

Specific examples of apparatus utilized to implement various aspects of the invention can include a computer server, a personal computer, a laptop computer, a handheld computer, an iPod, a mobile phone or other communication device, or any other processor and display equipped device.

In some preferred embodiments, apparatus includes a video and data server farm. The video and data server farm includes at least one video storage server that stores video image files containing video drive-by data that corresponds to a geographic location, a database server that processes a data query received from a user over the Internet that corresponds to a geographic location of interest, and an image server. In operation, the database server identifies video image files stored in the video storage server that correspond to the geographic location of interest contained in the data query, and transfers the video image files over a pre-processing network to the image processing server. The image processing server converts the video drive-by data to post processed video data corresponding to a desired image format, and transfers the post processed video data via post-processing network to the Internet response to the query.

A landing zone server can also be included which receives the video drive-by data from a portable memory device and permits the viewing and analysis of the video drive-by data prior to storage in the video storage server. Still further, a map server is preferably provided to present a static image an overhead view of the geographic location of interest.

Embodiments can also include one or more servers described above included in one or more physical units. Each server does not need to be a disparate apparatus. Still other embodiments can include one or more or the servers described above included in multiple physical units. Some embodiments can even include a single server, as described which includes multiple physical apparatus units at disparate locations.

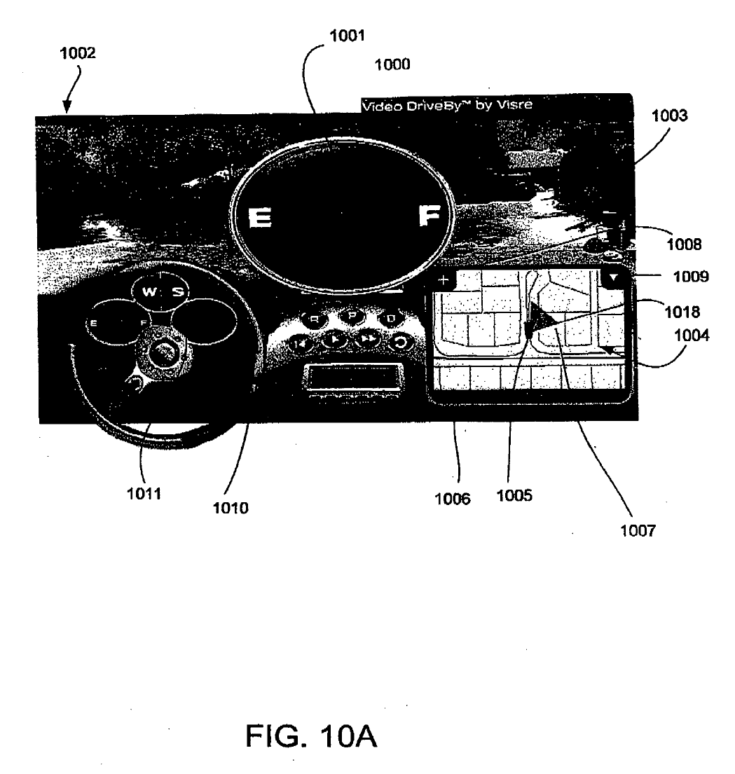

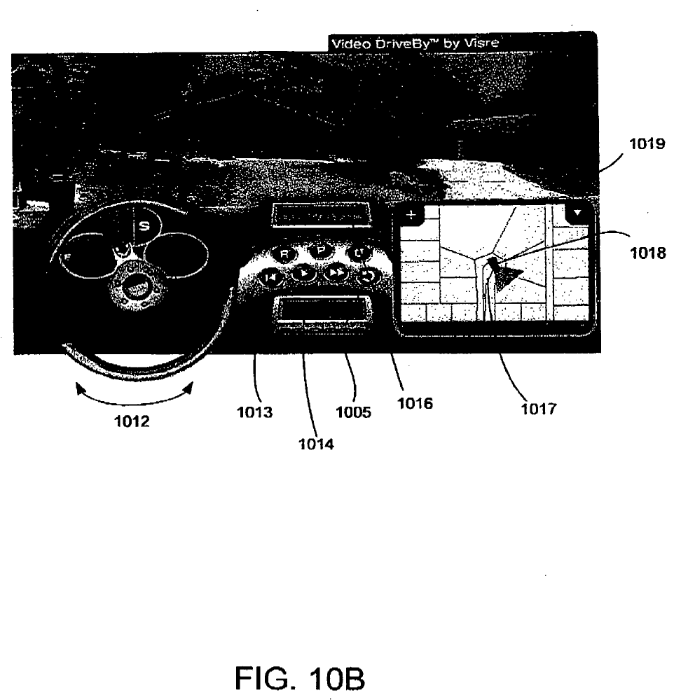

Referring now to FIGS. 10A and 10B some embodiments of the present invention can include an interactive interface for viewing a subject property 1000. When the interface is first accessed, a visual indicator 1001 can illustrate the progress of a data download pertaining to a subject property. In addition, individual progress indicators, such as a bar graph can indicate an amount of data received related to individual IDCDs. An image of the subject property 1003 can be displayed for the user to view.

In some embodiments, a map 1004 can indicate a geographic location in relation to other real estate parcels and roadways. According to the present invention, the location of a virtual vehicle 1018 can be illustrated to indicate a view of image data being viewed 1005. The vehicle 1018 can multiple IDCDs and an indicator of which IDCD can be shown 1011 which correlates with data being viewed at a given time. A route of image data capture can also be shown 1017 to illustrate various points of data viewing available to a user. A user interactive device 1010 can be provided to allow a user to rotate amongst various available views. In addition, navigation controls 1013 can be used to position the vehicle 1018 and IDCDs.

In some embodiments, an audio control can be provided to allow a user to select audio segments specific to a subject parcel or context sensitive to a view of image data currently on screen. The audio content can include, by way of non-limiting example: a description of a neighborhood, including demographics, school district, amenities, utility services, speed limit, tax base information, census data, and market data. Various button can be used to access various audio segments. A button can include for example, data descriptive of the subject property, including square footage, baths, rooms, amenities, lot size, roof type, and other data.

In a similar manner, if a property is listed for sale, a button can be associated with audio segments descriptive of a realtor listing the property and how to arrange for an on site viewing of the property.

In another aspect, some embodiments can include a snapshot control 1016. The snapshot control can be operative for one or more of: printing a current view; saving in a file a current view, and emailing or other electronic communication of a view. Some embodiments can also include a catalogue of snap shots taken.

Some embodiments can also include limiting snapshots a subject property or comparable properties.

Those schooled in the art will also understand that although the above describes multiple disparate image capture devices, some embodiments can include a single apparatus with multiple disparate inputs to capture image data, wherein two or more inputs capture data from a distinct spatial designations.

### CONCLUSION

A number of embodiments of the present invention have been described. Nevertheless, it will be understood that various modifications may be made without departing from the spirit and scope of the invention. For example, various methods or equipment may be used to implement the process steps described herein or to create a device according to the inventive concepts provided above and further described in the claims. In addition, various integration of components, as well as software and firmware can be implemented. Accordingly, other embodiments are within the scope of the following claims.

1. A method of providing image data related to a subject property, the method comprising the steps of:
receiving a digital request for image data of a subject property into a automated apparatus;
ascertaining with the automated apparatus if the requested data is stored in an available database;
if the data is available in the database, then transmitting the requested data from the database to the user via an interactive apparatus processor;
if the data is not available then proceed with steps comprising:
calculating an image data capture route;
dispatching an image data capture device rig to the subject property;
capturing image data descriptive of the subject property; and
transmitting the captured image data descriptive of the property to the user via an interactive apparatus.

2. The method of claim 1 additionally comprising the step of transmitting at least a portion of the captured image data descriptive of the property via a wireless transmission from a vehicle transporting the image data capture device rig to a server; and transmitting the captured image data descriptive of the property from the server to the user via an interactive apparatus.

3. The method of claim 2 additionally comprising the step of storing at least a portion of the captured image data in a storage device located in the vehicle.

4. The method of claim 3 additionally comprising the step of transferring image data from the storage device to the server.

5. The method of claim 3 additionally comprising the step of storing the image data capture route and rig configuration.

6. The method of claim 3 additionally comprising the step of storing an image data capture device rig identifier.

7. The method of claim 3 additionally comprising the step of correlating the image data capture route with a map indicating parcels and roadways.

8. The method of claim 3 additionally comprising the step of receiving a time criteria associated with the image data capture and ascertaining if the time of image data capture correlates with the time criteria received.

9. The method of claim 8 additionally comprising the steps of:
calculating a image data capture route;
dispatching an image data capture rig ; and
capturing image data; based upon the time criteria.

10. The method of claim 8, additionally comprising the steps of:
ascertaining if stored data correlates with the time criteria; and
transmitting the stored data to the user if the stored data does correlate with the time criteria.

11. The method of claim 3 additionally wherein the user interactive apparatus comprises:
an area of image data display; and
a map indicating the location of an image data capture device at the time of acquisition of the displayed imaged data.

12. The method of claim 11 additionally wherein the user interactive apparatus comprises:
a snapshot control operative to create a still image of image data displayed.

13. The method of claim 11 additionally wherein the user interactive apparatus comprises:
a visual indication of multiple image data capture devices operative to capture image data; and
an indication of which image data capture device captured image data being simultaneously displayed.

14. The method of claim 11 wherein the user interactive apparatus comprises:
an indication of a route traveled by the image data capture device rig.

15. The method of claim 14 wherein the user interactive apparatus comprises:
user interactive controls to virtually traverse the route traveled by the image data capture device rig and display image data based upon input received from the controls.

16. The method of claim 3 wherein at least a portion of the image data is delivered to a user via a certified document.

17. An apparatus for processing data related to a location, the apparatus comprising:
a processor;
a storage device, said storage device storing disparate image data captured during a same time period from more than one image data capture device and at least a portion of image data captured by a given disparate image data capture device relates to overlapping subject matter with a portion of image data captured by another disparate image data capture device; and
executable software stored on the storage device and executable on demand, the software operative with the processor to cause the server to:
receive a digital request for image data of a subject property into a automated apparatus;
ascertain with the automated apparatus if the requested data is stored in an available database;
if the data is available in the database, then transmitting the requested data from the database to the user via an interactive apparatus processor;
if the data is not available then proceed with steps comprising:
calculate an image data capture route;
dispatch an image data capture device rig to the subject property with an instruction to capturing image data descriptive of the subject property;
receive captured image data descriptive of the property.

18. The apparatus of claim 17 additionally operative to transmit the captured image data descriptive of the property to the user via an interactive apparatus.

19. The apparatus of claim 17 wherein the software is additionally operative with the processor to transmit at least a portion of the captured image data descriptive of the property via a wireless transmission from a vehicle transporting the image data capture device rig to a server; and transmitting the captured image data descriptive of the property from the server to the user via an interactive apparatus.

20. The apparatus of claim 17 wherein the software is additionally operative with the processor to store at least a portion of the captured image data in a storage device located in the vehicle.
